(19) United States
(12) Patent Application Publication
(10) Pub. No.: US 2022/0089829 A1
(43) Pub. Date: Mar. 24, 2022

(54) POLYIMIDE PRECURSOR SOLUTION AND METHOD FOR PRODUCING POROUS POLYIMIDE FILM

(71) Applicant: FUJIFILM BUSINESS INNOVATION CORP., Tokyo (JP)

(72) Inventors: Tomoyo OKUBO, Minamiashigara-shi (JP); Shunsuke NOZAKI, Minamiashigara-shi (JP); Tomoya SASAKI, Minamiashigara-shi (JP); Hidekazu HIROSE, Minamiashigara-shi (JP)

(73) Assignee: FUJIFILM BUSINESS INNOVATION CORP., Tokyo (JP)

(21) Appl. No.: 17/129,286

(22) Filed: Dec. 21, 2020

(30) Foreign Application Priority Data
Sep. 23, 2020 (JP) 2020-158949

(51) Int. Cl. C08J 9/26; C08L 25/14

(52) U.S. Cl. CPC C08J 9/26; C08J 2479/08; C08J 2325/14; C08L 25/14

(57) ABSTRACT

A polyimide precursor solution, includes: a polyimide precursor; resin particles having a volume average particle diameter of 5 nm or more and 100 nm or less, and having a volume particle size distribution wherein a ratio of a volume frequency of resin particles having a particle diameter of 150 nm or more to a volume frequency of all of the resin particles in the polyimide precursor solution is 5% or less; and an aqueous solvent containing water.

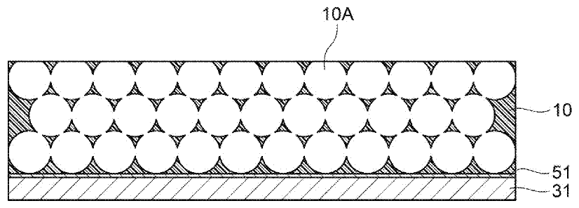

### CROSS-REFERENCE TO RELATED APPLICATIONS

This application is based on and claims priority under 35 USC 119 from Japanese Patent Application No. 2020-158949 filed on Sep. 23, 2020.

### BACKGROUND

### Technical Field

The present invention relates to a polyimide precursor solution and a method for producing a porous polyimide film.

### RELATED ART

The polyimide resin is a material having excellent mechanical strength, chemical stability, and heat resistance, and a porous polyimide film having these properties is attracting attention.

For example, Patent Literature 1 discloses a method for producing a porous polyimide film using a polyimide precursor solution which contains resin particles and a polyimide precursor, in which a volume particle size distribution of the resin particles in the polyimide precursor solution has at least one maximum value, and a ratio of a volume frequency of the maximum value having the largest volume frequency among the maximum values is 90% or more and 100% or less with respect to the volume frequency of all maximum values in the volume particle size distribution.

Patent Literature 1: JP-A-2018-138645

### SUMMARY

Among the porous polyimide films, in recent years, the demand for a porous polyimide film having a pore diameter of 5 nm or more and 100 nm or less is increasing. The above porous polyimide film is obtained, for example, by using a polyimide precursor solution containing a polyimide precursor, resin particles having a particle diameter of 5 nm or more and 100 nm or less, and an aqueous solvent.

However, when a porous polyimide film is produced using the above polyimide precursor solution, a porous polyimide film having a large variation in pore diameter due to aggregation of particles may be obtained.

Aspects of non-limiting embodiments of the present disclosure relate to a polyimide precursor solution from which a porous polyimide film having a reduced variation in pore diameter may be obtained as compared with a case of containing a polyimide precursor, resin particles having a volume average particle diameter of 5 nm or more and 100 nm or less, and having a volume particle size distribution wherein a ratio of a volume frequency of resin particles having a particle diameter of 150 nm or more to a volume frequency of all of the resin particles in the polyimide precursor solution is more than 5%, and an aqueous solvent or a case of containing a polyimide precursor, resin particles having a volume average particle diameter of 5 nm or more and 100 nm or less, and an aqueous solvent, and containing no water-soluble surfactant.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a polyimide precursor solution, containing:

a polyimide precursor;

resin particles having a volume average particle diameter of 5 nm or more and 100 nm or less, and having a volume particle size distribution wherein a ratio of a volume frequency of resin particles having a particle diameter of 150 nm or more to a volume frequency of all of the resin particles in the polyimide precursor solution is 5% or less; and

an aqueous solvent containing water.

### BRIEF DESCRIPTION OF THE DRAWINGS

Exemplary embodiment of the present invention will be described in detail based on the following FIGURE, wherein:

The FIGURE is a schematic view showing a form of a porous polyimide film obtained by using a polyimide precursor solution according to the present exemplary embodiment.

### DETAILED DESCRIPTION

Hereinafter, an exemplary embodiment as an example of the present invention will be described.

### [Polyimide Precursor Solution]

### <First Mode>

A polyimide precursor solution according to the first mode contains: a polyimide precursor; resin particles having a volume average particle diameter of 5 nm or more and 100 nm or less, and having a volume particle size distribution wherein a ratio of a volume frequency of resin particles having a particle diameter of 150 nm or more to a volume frequency of all of the resin particles in the polyimide precursor solution is 5% or less; and an aqueous solvent containing water.

Herein, in the present description, the terms “volume average particle diameter” and “volume particle size distribution” of the resin particles mean “volume average particle diameter” and “volume particle size distribution” of the resin particles in the polyimide precursor solution, respectively.

The volume particle size distribution of the resin particles in the polyimide precursor solution is measured as follows.

The polyimide precursor solution to be measured is used as it is, and the volume particle size distribution of the resin particles in the polyimide precursor solution is measured by a Coulter counter LS13 (manufactured by Beckman Coulter).

A cumulative distribution by volume is drawn from the side of the smallest diameter with respect to particle diameter ranges (so-called channels) separated using the above volume particle size distribution, and a particle diameter corresponding to the cumulative percentage of 50% with respect to the entire particles is set as a volume average particle diameter of the resin particles.

In addition, the ratio of the volume frequency of the particles having a particle diameter of 150 nm or more is defined as the ratio of the volume frequency of the particles having a particle diameter of 150 nm or more to the volume frequency of the all measured particles in the volume particle size distribution.

When using the polyimide precursor solution according to the first mode, a porous polyimide film having a reduced variation in pore diameter may be obtained.

In recent years, among the porous polyimide films, the demand for a porous polyimide film having a pore diameter of 5 nm or more and 100 nm or less is increasing. Examples of the polyimide precursor solution for producing a porous polyimide film having a pore diameter of 5 nm or more and 100 nm or less include a polyimide precursor solution containing a polyimide precursor, resin particles having a particle diameter of 5 nm or more and 100 nm or less, and an aqueous solvent.

However, when a polyimide precursor solution containing resin particles having a particle diameter of 5 nm or more and 100 nm or less is used, a porous polyimide film having a large variation in pore diameter may be obtained. Although the reason is not clear, it is presumed that since resin particles having a small particle diameter tend to aggregate in an aqueous solvent, the degree of aggregation varies, whereby the pore diameter of the obtained porous polyimide film also varies.

In a case where a porous polyimide film having a large variation in pore diameter is used as an electrolyte membrane for, for example, a lithium ion secondary battery, a lithium metal secondary battery, and a fuel cell, when a reaction proceeds specifically in pores having a large diameter, the deterioration of the secondary battery or the like may be accelerated. Therefore, for example, when a porous polyimide film is used as the electrolyte membrane for the secondary battery or the like, it is preferable that the variation in pore diameter of the porous polyimide film is small from the viewpoint of preventing deterioration of the secondary battery or the like.

In contrast, in the first mode, the resin particles contained in the polyimide precursor solution have a volume average particle diameter of 5 nm or more and 100 nm or less, and have a ratio of the volume frequency of the particles having a particle diameter of 150 nm or more of 5% or less of all particles in the volume particle size distribution. That is, in the polyimide precursor solution in first mode, the particles having a particle diameter of 150 nm or more due to the aggregation of the resin particles is 5% or less of all particles, and 95% of the resin particles are dispersed without aggregation or even if aggregated, the aggregated particles are particles having a particle diameter of less than 150 nm. Therefore, it is presumed that by producing a porous polyimide film using the polyimide precursor solution in the first mode, a porous polyimide film having a reduced variation in pore diameter may be obtained.

### <Second Mode>

A polyimide precursor solution according to the second mode contains: a polyimide precursor; resin particles having a volume average particle diameter of 5 nm or more and 100 nm or less, an aqueous solvent containing water; and a water-soluble surfactant having a content in a range of 3.3 mass % or more and 170 mass % or less with respect to the polyimide precursor.

When using the polyimide precursor solution according to the second mode, a porous polyimide film having a reduced variation in pore diameter may be obtained. The reason is not clear, but is presumed as follows.

As described above, when a polyimide precursor solution containing resin particles having a particle diameter of 5 nm or more and 100 nm or less is used, a porous polyimide film having a large variation in pore diameter may be obtained. It is presumed that the reason is that resin particles having a small particle diameter tend to aggregate in an aqueous solvent, and the degree of aggregation varies.

In contrast, in the second mode, the polyimide precursor solution contains the water-soluble surfactant having a content in the range of 3.3 mass % or more and 170 mass % or less with respect to the entire polyimide precursor solution. Therefore, the dispersibility of the resin particles in the polyimide precursor solution is better than that in the case where the water-soluble surfactant is not contained or the content of the water-soluble surfactant is less than 3.3 mass %. Therefore, it is presumed that when producing a porous polyimide film using the polyimide precursor solution in the second mode, a porous polyimide film having a reduced variation in pore diameter may be obtained.

Hereinafter, a polyimide precursor solution corresponding to both the polyimide precursor solution according to the first mode and the polyimide precursor solution according to the second mode will be referred to as a “polyimide precursor solution according to the present exemplary embodiment”. However, an example of the polyimide precursor solution according to the present exemplary embodiment may be any polyimide precursor solution corresponding to at least one of the polyimide precursor solution according to the first mode and the polyimide precursor solution according to the second mode.

### <Polyimide Precursor>

The polyimide precursor solution according to the present exemplary embodiment contains a polyimide precursor.

The polyimide precursor is, for example, a resin (that is, polyimide precursor) having a repeating unit represented by the following general formula (I).

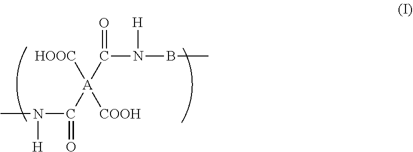

In the general formula (I), A represents a tetravalent organic group and B represents a divalent organic group.

Here, in the general formula (I), the tetravalent organic group represented by A is a residue obtained by removing four carboxyl groups from a tetracarboxylic dianhydride as a raw material.

On the other hand, the divalent organic group represented by B is a residue obtained by removing two amino groups from a diamine compound as a raw material.

That is, the polyimide precursor having a repeating unit represented by the general formula (I) is a polymer of a tetracarboxylic dianhydride and a diamine compound.

Examples of the tetracarboxylic dianhydride include both an aromatic compound and an aliphatic compound, and the aromatic compound is preferred. That is, in the general formula (I), the tetravalent organic group represented by A is preferably an aromatic organic group.

Examples of an aromatic tetracarboxylic dianhydride include pyromellitic dianhydride, 3,3,4,4-benzophenone tetracarboxylic dianhydride, 3,3,4,4,-biphenyl sulfonetetracarboxylic dianhydride, 1,4,5,8-naphthalenetetracarboxylic dianhydride, 2,3,6,7-naphthalenetetracarboxylic dianhydride, 3,3,4,4-biphenyl ether tetracarboxylic dianhydride, 3,3,4,4-Edimethyldiphenylsilanetetracarboxylic dianhydride, 3,3,4,4-tetraphenylsilanetetracarboxylic dianhydride, 1,2,3,4-frantetracarboxylic dianhydride, 4,4-bis(3,4-dicarboxyphenoxy)diphenylsulfide dianhydride, 4,4-bis(3,4-dicarboxyphenoxy)diphenylsulfone dianhydride, 4,4-bis(3,4-dicarboxyphenoxy)diphenylpropane dianhydride, 3,3,4,4-perfluoroisopropyridene diphthalic dianhydride, 3,3,4,4-biphenyltetracarboxylic dianhydride, 2,3,3,4-biphenyltetracarboxylic dianhydride, bis(phthalic acid) phenylphosphine oxide dianhydride, p-phenylene-bis(triphenylphthalic acid)dianhydride, m-phenylene-bis(triphenylphthalic acid)dianhydride, bis(triphenylphthalic acid)-4,4-diphenyl ether dianhydride, and bis(triphenylphthalic acid)-4,4-diphenylmethane dianhydride.

Examples of an aliphatic tetracarboxylic dianhydride include: aliphatic or alicyclic tetracarboxylic dianhydrides such as butanetetracarboxylic dianhydride, 1,2,3,4-cyclobutanetetracarboxylic dianhydride, 1,3-dimethyl-1,2,3,4-cyclobutanetetracarboxylic dianhydride, 1,2,3,4-cyclopentanetetracarboxylic dianhydride, 2,3,5-tricarboxycyclopentyl acetate dianhydride, 3,5,6-tricarboxynorbonan-2-acetate dianhydride, 2,3,4,5-tetrahydrofuran tetracarboxylic dianhydride, 5-(2,5-dioxotetrahydrofuryl)-3-methyl-3-cyclohexene-1,2-dicarboxylic acid dianhydride, and bicyclo[2,2,2]-octo-7-ene-2,3,5,6-tetracarboxylic dianhydride; and aliphatic tetracarboxylic dianhydrides having an aromatic ring such as 1,3,3a,4,5,9b-hexahydro-2,5-dioxo-3-franyl)-naphtho[1,2-c]furan-1,3-dione, 1,3,3a,4,5,9b-hexahydro-5-methyl -5-(tetrahydro-2,5-dioxo-3-franyl)-naphtho[1,2-c]furan-1,3-dione, and 1,3,3a,4,5,9b-hexahydro-8-methyl-5-(tetrahydro-2,5-dioxo-3-franyl)-naphtho[1,2-c]furan-1,3-dione.

Among these, the tetracarboxylic dianhydride is preferably an aromatic tetracarboxylic dianhydride. Specifically, preferred are pyromellitic dianhydride, 3,3,4,4,-biphenyltetracarboxylic dianhydride, 2,3,3,4-biphenyltetracarboxylic dianhydride, 3,3,4,4-biphenyl ether tetracarboxylic dianhydride, and 3,3,4,4-benzophenone tetracarboxylic dianhydride, more preferred are pyromellitic dianhydride, 3,3,4,4-biphenyltetracarboxylic dianhydride, and 3,3,4,4,-benzophenone tetracarboxylic dianhydride, and particularly preferred is 3,3,4,4-biphenyltetracarboxylic dianhydride.

The tetracarboxylic dianhydride may be used alone or in combination of two or more thereof.

When two or more tetracarboxylic dianhydrides are used in combination, aromatic tetracarboxylic dianhydrides or aliphatic tetracarboxylic acids may be used in combination, or an aromatic tetracarboxylic dianhydride and an aliphatic tetracarboxylic dianhydride may be used in combination.

On the other hand, the diamine compound is a diamine compound having two amino groups in the molecular structure thereof. Examples of the diamine compound include both aromatic and aliphatic diamine compounds, and aromatic diamine compounds are preferred. That is, in the general formula (I), the divalent organic group represented by B is preferably an aromatic organic group.

Examples of the diamine compound include: aromatic diamines such as p-phenylenediamine, m-phenylenediamine, 4,4-diaminodiphenylmethane, 4,4-diaminodiphenylethane, 4,4-diaminodiphenyl ether, 4,4-diaminodiphenyl sulfide, 4,4-diaminodiphenyl sulfone, 1,5-diaminonaphthalene, 3,3-dimethyl-4,4-diaminobiphenyl, 5-amino-1-(4-aminophenyl)-1,3,3-trimethylindane, 6-amino-1-(4-aminophenyl)-1,3,3-trimethylindane, 4,4-diaminobenzanilide, 3,5-diamino-3-trifluoromethylbenzanilide, 3,5-diamino-4-trifluoromethylbenzanilide, 3,4-diaminodiphenyl ether, 2,7-diaminofluorene, 2,2-bis(4-aminophenyl)hexafluoropropane, 4,4-methylene-bis(2-chloroaniline), 2,2,5,5-tetrachloro-4,4-diaminobiphenyl, 2,2-dichloro-4,4-amino-5,5-dimethoxybiphenyl, 3,3-dimethoxy-4,4-diaminobiphenyl, 4,4-diamino-2,2bis(trifluoromethyl)biphenyl, 2,2-bis[4-(4-aminophenoxy)phenyl]propane, 2,2-bis[4-(4-aminophenoxy)phenyl]hexafluoropropane, 1,4-bis(4-aminophenoxy)benzene, 4,4-bis(4-aminophenoxy)-biphenyl, 1,3-bis(4-aminophenoxy) benzene, 9,9-bis(4-aminophenyl)fluorene, 4,4-(p-phenyl ene i sopropylidene)bi saniline, 4,4-(m-phenylene isopropylidene)bisaniline, 2,2-bis[4-(4-amino-2-trifluoromethylphenoxy)phenyl]hexafluoropropane, and 4,4-bis[4-(4-amino-2-trifluoromethyl)phenoxy]-octafluorobiphenyl; aromatic diamines having two amino groups bonded to an aromatic ring and a hetero atom other than the nitrogen atom of the amino groups, such as diaminotetraphenylthiophene; and aliphatic diamines and alicyclic diamines such as 1,1-meta-xylylene diamine, 1,3-propane diamine, tetramethyl enediamine, pentamethyl enediamine, octamethyl enediamine, nonamethylenediamine, 4,4-diaminoheptamethylenediamine, 1,4-diaminocyclohexane, isophorone diamine, tetrahydrodicyclopentadienylenediamine, hexahydro-4,7-methanoindanylene dimethylenediamine, tricyclo[6,2,1,0^{2.7}]-undecylenic methyldiamine, and 4,4-methylenebis(cyclohexylamine).

Among these, the diamine compound is preferably an aromatic diamine compound. Specifically, preferred are p-phenylenediamine, m-phenylenediamine, 4,4-diaminodiphenylmethane, 4,4 diaminodiphenyl ether, 3,4-diaminodiphenyl ether, 4,4-diaminodiphenyl sulfide, and 4,4-diaminodiphenyl sulfone, and particularly preferred are 4,4-diaminodiphenyl ether and p-phenylenediamine.

The diamine compound may be used alone or in combination of two or more thereof. When two or more diamine compounds are used in combination, aromatic diamine compounds or aliphatic diamine compounds may be used in combination, or an aromatic diamine compound and an aliphatic diamine compound may be used in combination.

The weight average molecular weight of the polyimide precursor for use in the present exemplary embodiment is preferably 5,000 or more and 300,000 or less, and more preferably 10,000 or more and 150,000 or less.

The weight average molecular weight of the polyimide precursor is measured by a gel permeation chromatography (GPC) method under the following measurement conditions.
Column: Tosoh TSKgela-M (7.8 mm I.D×30 cm)
Eluent: DMF (dimethylformamide)/30 mM LiBr/60 mM phosphoric acid
Flow rate: 0.6 mL/min
Injection amount: 60 μL
Detector: RI (Differential Refractometer)

The content of the polyimide precursor contained in the polyimide precursor solution according to the present exemplary embodiment is preferably 0.1 mass % or more and 40 mass % or less, and more preferably 1 mass % or more and 25 mass % or less, with respect to the total mass of the polyimide precursor solution.

### <Resin Particles>

The polyimide precursor solution according to the present exemplary embodiment contains resin particles.

The resin particles are not particularly limited, and are preferably resin particles that are insoluble in an aqueous solvent and insoluble in a polyimide precursor solution. The “resin particles that are insoluble” includes, in addition to resin particles that do not dissolve in a target liquid at 25° C., resin particles that dissolve in the range of 3 mass % or less in a target liquid at 25° C.

Examples of the resin particles include resin particles made of a resin other than a polyimide. Specific examples of the resin particles include resin particles obtained by polycondensing polymerizable monomers, such as a polyester resin and a urethane resin, and resin particles obtained by radical polymerization of polymerizable monomers, such as a vinyl resin, an olefin resin, and a fluororesin. Examples of the resin particles obtained by radical polymerization include resin particles of a (meth)acrylic resin, a (meth)acrylic acid ester resin, a styrene-(meth)acrylic resin, a polystyrene resin, and a polyethylene resin.

Among these, the resin particles are preferably resin particles obtained by radical polymerization from the viewpoint of ease of production. In addition, the resin particles preferably contain a vinyl resin from the viewpoint of ease of production and dispersibility in the polyimide precursor solution. The reason why the dispersibility is improved by containing a vinyl resin in the resin particles is not clear, but it is presumed that it is due to the characteristics of the surface functional groups of the particles.

Among the vinyl resin, the resin particles more preferably contain at least one (hereinafter also referred to as “specific resin”) selected from the group consisting of a polystyrene resin, a (meth)acrylic resin, a (meth)acrylic acid ester resin, and a styrene-(meth)acrylic resin from the viewpoint of ease of production and dispersibility in the polyimide precursor solution. The reason why the dispersibility is improved when the resin particles contain the above specific resin is not clear, but it is presumed that it is due to the characteristics of the surface functional groups of the particles.

In the present exemplary embodiment, “(meth)acrylic” means to include both “acrylic” and “methacrylic”.

When the resin particles are particles containing a vinyl resin, the resin particles are obtained by polymerizing a monomer. Examples of the monomer of the vinyl resin include monomers including: styrenes having a styrene skeleton, such as styrene, alkyl-substituted styrene (for example, α-methylstyrene, 2-methylstyrene, 3-methylstyrene, 4-methylstyrene, 2-ethylstyrene, 3-ethylstyrene, and 4-ethylstyrene), halogen-substituted styrene (for example, 2-chlorostyrene, 3-chlorostyrene, and 4-chlorostyrene), and vinyl naphthalene; esters having a vinyl group, such as methyl (meth)acrylate, ethyl (meth)acrylate, n-propyl (meth)acrylate, n-butyl (meth)acrylate, lauryl (meth)acrylate, 2-ethylhexyl (meth)acrylate, trimethylolpropane trimethacrylate (TMPTMA); vinyl nitriles such as acrylonitrile and methacrylonitrile; vinyl ethers such as vinyl methyl ether and vinyl isobutyl ether; vinyl ketones such as vinyl methyl ketone, vinyl ethyl ketone, and vinyl isopropenyl ketone; acids such as (meth)acrylic acid, maleic acid, cinnamic acid, fumaric acid, and vinyl sulfonic acid; and bases such as ethyleneimine, vinylpyridine, and vinylamine.

The vinyl resin may be a resin obtained by using these monomers alone, or a resin which is a copolymer using obtained by two or more of these monomers.

The vinyl resin may be polymerized by using, as other monomers, a monofunctional monomers such as vinyl acetate, a bifunctional monomer such as ethylene glycol dimethacrylate, nonane diacrylate, and decanediol diacrylate, or a polyfunctional monomer such as trimethylolpropane triacrylate and trimethylolpropane trimethacrylate in combination.

The resin particles preferably have an acidic group on the surface from the viewpoint of improving dispersibility. It is considered that the acidic group present on the surface of the resin particles functions as a dispersant for the resin particles by forming a salt with a base such as an organic amine compound for dissolving the polyimide precursor in an aqueous solvent. Therefore, it is considered that the dispersibility of the resin particles in the polyimide precursor solution is improved.

The acidic group contained on the surface of the resin particles is not particularly limited, and may be at least one selected from the group consisting of a carboxy group, a sulfonic acid group, and a phenolic hydroxy group. Among these, a carboxy group is preferred.

The monomer for having an acidic group on the surface of the resin particles is not particularly limited as long as it is a monomer having an acidic group. Examples of the monomer for having an acidic group on the surface of the resin particles include a monomer having a carboxy group, a monomer having a sulfonic acid group, a monomer having a phenolic hydroxy group, and a salt thereof.

Specific examples include: a monomer having a sulfonic acid group, such as p-styrene sulfonic acid and 4-vinylbenzene sulfonic acid; a monomer having a phenolic hydroxy group, such as 4-vinyldihydrocinnamonic acid, 4-vinylphenol, and 4-hydroxy-3-methoxy-1-propenylbenzene; a monomer having a carboxy group, such as acrylic acid, crotonic acid, methacrylic acid, 3-methyl crotonic acid, fumaric acid, maleic acid, 2-m ethylisocrotonic acid, 2,4-hexadienedioic acid, 2-pentenoic acid, sorbic acid, citraconic acid, 2-hexenoic acid, and monoethyl fumarate; and a salt thereof. These monomers having an acidic group may be mixed and polymerized with a monomer having no acidic group, or a monomer having no acidic group may be polymerizing and granulated, and then a monomer having an acidic group on the surface may be polymerized. These monomers may be used alone or in combination of two or more.

Among these, preferred is a monomer having a carboxy group, such as acrylic acid, crotonic acid, methacrylic acid, 3-methyl crotonic acid, fumaric acid, maleic acid, 2-methylisocrotonic acid, 2,4-hexadienedioic acid, 2-pentenoic acid, sorbic acid, citraconic acid, 2-hexenoic acid, monoethyl fumarate, and a salt thereof. The monomer having a carboxy group may be used alone or in combination of two or more thereof.

That is, the resin particles having an acidic group on the surface preferably have a skeleton derived from a monomer having a carboxy group at least one selected from the group consisting of acrylic acid, crotonic acid, methacrylic acid, 3-methyl crotonic acid, fumaric acid, maleic acid, 2-methyli socrotonic acid, 2,4-hexadienedioic acid, 2-pentenoi c acid, sorbic acid, citraconic acid, 2-hexenoic acid, monoethyl fumarate, and a salt thereof.

When a monomer having an acidic group and a monomer having no acidic group are mixed and polymerized, the amount of the monomer having an acidic group is not particularly limited. However, when the amount of the monomer having an acidic group is too small, the dispersibility of the resin particles in the polyimide precursor solution may decrease, and when the amount of the monomer having an acidic group is too large, agglomerates of the polymer may be generated during emulsion polymerization. Therefore, the monomer having an acidic group is preferably 0.3 mass % or more and 20 mass % or less, more preferably 0.5 mass % or more and 15 mass % or less, and particularly preferably 0.7 mass % or more and 10 mass % or less based on all monomers.

On the other hand, when a monomer having no acidic group is emulsion-polymerized and then a monomer having an acidic group is further added for polymerization, from the viewpoint as described above, the amount of the monomer having an acidic group is preferably 0.01 mass % or more and 10 mass % or less, more preferably 0.05 mass % or more and 7 mass % or less, and particularly preferable 0.07 mass % or more and 5 mass % or less based on all monomers.

When the resin particles are particles containing a vinyl resin and the monomer used for polymerizing the vinyl resin contains styrene, the ratio of styrene to all the monomer components is preferably 20 mass % or more and 100 mass % or less, and more preferably 40 mass % or more and 100 mass % or less.

The resin particles may be used alone or in combination of two or more thereof.

The resin particles may or may not be cross-linked.

When the resin particles are particles containing a vinyl resin, for example, cross-linked resin particles may be obtained by using a bifunctional monomer and a polyfunctional monomer in combination as the monomer.

The shape of the resin particles is preferably spherical.

When the spherical resin particles are used and the resin particles are removed from the polyimide film to prepare a porous polyimide film, a porous polyimide film having spherical pores may be obtained.

The “spherical” in particles includes both a spherical shape and a substantially spherical shape (that is, a shape close to a spherical shape). The “spherical” specifically means that particles having a ratio (major axis/minor axis) of a major axis to a minor axis of 1 or more and less than 1.5 is present in a ratio of more than 80%. The ratio of particles having a ratio (major axis/minor axis) of a major axis to a minor axis ratio of 1 or more and less than 1.5 is preferably 90% or more. The closer the ratio of a major axis to a minor axis ratio is 1, the closer the particle becomes to a spherical shape.

The glass transition temperature of the resin particles is, for example, 60° C. or higher, and, from the viewpoints of maintaining the shape of the particles in the process of producing the polyimide precursor solution and in the process of coating the polyimide precursor solution and drying the coating film (before removing the resin particles) during the production of the porous polyimide film, is preferably 70° C. or higher, and more preferably 80° C. or higher.

The glass transition temperature is obtained from a DSC curve obtained by differential scanning calorimetry (DSC), and is more specifically obtained by the “extrapolated glass transition onset temperature” described in JIS K 7121:1987 “Method for measuring glass transition temperature of plastics”, which is a method for obtaining the glass transition temperature.

The volume average particle diameter of the resin particles in the polyimide precursor solution is 5 nm or more and 100 nm or less, and, from the viewpoints of particle dispersion stability and production, is preferably 10 nm or more and 95 nm or less, and more preferably 20 nm or more and 90 nm or less.

The ratio of the volume frequency of the resin particles having a particle diameter of 150 nm or more to the volume frequency of all of the resin particles in the polyimide precursor solution is preferably 5% or less, more preferably 3% or less, and still more preferably 1% or less, from the viewpoint of obtaining a porous polyimide film having a small variation in pore diameter.

The method of setting the ratio of the volume frequency of the particles having a particle diameter of 150 nm or more to the above range is not particularly limited, and examples thereof include a method of containing a water-soluble surfactant in the polyimide precursor solution.

The volume particle size distribution index (GSDv) of the resin particles in the polyimide precursor solution is preferably 1.40 or less, more preferably 1.35 or less, and still more preferably 1.30 or less, from the viewpoint of obtaining a porous polyimide film having a small variation in pore diameter. In particular, it is preferable that the volume particle size distribution of the resin particles in the polyimide precursor solution has only one peak.

The volume particle size distribution index of the resin particles in the polyimide precursor solution is obtained from the volume particle size distribution obtained by the above measurement method. Specifically, the volume cumulative distribution is drawn from the side of the smallest diameter with respect to the particle diameter ranges (so-called channels), and the value of (D84v/D16v)^{1/2} calculated using the particle diameter D16v corresponding to the cumulative percentage of 16% and the particle diameter D84v corresponding to the cumulative percentage of 84% is used as the volume particle size distribution index.

When it is difficult to measure the volume particle size distribution of the resin particles in the polyimide precursor solution by the above method, it may be measured by a method such as a dynamic light scattering method.

The content of the resin particles in the polyimide precursor solution is preferably in the range of 65 parts by mass or more and 600 parts by mass or less, is more preferably 80 parts by mass or more and 500 parts by mass or less, and is still more preferably 120 parts by mass or more and 400 parts by mass or less, with respect to 100 parts by mass of the polyimide precursor.

### <Aqueous Solvent>

The polyimide precursor solution according to the present exemplary embodiment contains an aqueous solvent.

The aqueous solvent contains water.

Examples of water include distilled water, ion-exchanged water, deionized water, ultrafiltered water, and pure water.

The content of water with respect to the entire aqueous solvent is preferably 50 mass % or more and 100 mass % or less, more preferably 70 mass % or more and 100 mass % or less, and still more preferably 80 mass % or more and 100 mass % or less. In the present exemplary embodiment, when the content of water is within the above range, a porous polyimide film having a reduced variation in pore diameter may be obtained.

Here, the aqueous solvent is a general term for water and a water-soluble organic solvent. Further, “water-soluble” means that the target substance dissolves in water in an amount of 1 mass % or more at 25° C.

### (Organic Amine Compound)

The aqueous solvent preferably contains an organic amine compound as one of the water-soluble organic solvents.

The organic amine compound is a compound that amine-salifies thepolyimide precursor (specifically, a carboxyl group of the polyimide precursor) to increase the solubility in an aqueous solvent and that also functions as an imidization accelerator. Specifically, the organic amine compound is preferably an amine compound having a molecular weight of 170 or less. The organic amine compound is a compound excluding the diamine compound which is a raw material of the polyimide precursor.

The organic amine compound is preferably a water-soluble compound. The “water-soluble” means that the target substance dissolves in water in an amount of 1 mass % or more at 25° C.

Examples of the organic amine compound include a primary amine compound, a secondary amine compound, and a tertiary amine compound.

Among these, the organic amine compound is preferably at least one selected from a secondary amine compound and a tertiary amine compound (in particular, a tertiary amine compound). When a tertiary amine compound or a secondary amine compound (in particular, a tertiary amine compound) is applied as the organic amine compound, the solubility of the polyimide precursor in a solvent is easily increased, the film-forming property is easily improved, and the storage stability of the polyimide precursor solution is easily improved.

In addition, examples of the organic amine compound also include a polyvalent amine compound having a valency of 2 or more in addition to a monovalent amine compound. When a polyvalent amine compound having a valency of 2 or more is applied, a pseudo-cross-linked structure is easily formed between molecules of the polyimide precursor, and the storage stability of the polyimide precursor solution is easily improved.

Examples of the primary amine compound include methylamine, ethylamine, n-propylamine, isopropylamine, 2-ethanolamine, and 2-amino-2-methyl-1-propanol.

Examples of the secondary amine compound include dimethylamine, 2-(methylamino)ethanol, 2-(ethylamino)ethanol, and morpholine.

Examples of the tertiary amine compound include 2-dimethylaminoethanol, 2-diethylaminoethanol, 2-dimethylaminopropanol, pyridine, triethylamine, picoline, N-alkylmorpholine (for example, N-methylmorpholine and N-ethylmorpholine), 1,2-dimethylimidazole, 2-ethyl-4-methylimidazole, and N-alkylpiperidine (for example, N-methylpiperidine and N-ethylpiperidine).

Among these, a tertiary amine compound is preferred, N-alkylmorpholine is more preferred, and N-methylmorpholine is particularly preferred.

The organic amine compound may be used alone or in combination of two or more thereof.

The content of the organic amine compound is preferably 40 parts by mass or more and 100 parts by mass or less, more preferably 45 parts by mass or more and 90 parts by mass or less, and still more preferably 50 parts by mass or more and 80 parts by mass or less, with respect to 100 parts by mass of the polyimide precursor.

### (Other Water-soluble Organic Solvents)

The aqueous solvent may contain other water-soluble organic solvents, if necessary.

Examples of the other water-soluble organic solvents include an aprotic polar solvent, a water-soluble ether solvent, a water-soluble ketone solvent, and a water-soluble alcohol solvent.

Examples of the aprotic polar solvent include N-methyl-2-pyrrolidone (NMP), N,N-dimethylformamide (DMF), 1,3-dimethyl-2-imidazolidinone (DMI), N,N-dimethylacetamide (DMAc), N,N-diethylacetamide (DEAc), dimethyl sulfoxide (DMSO), hexamethylenephosphoramide (HMPA), N-methylcaprolactam, N-acetyl-2-pyrrolidone, and 1,3-dimethyl-imidazolidone.

The water-soluble ether solvent is a water-soluble solvent having an ether bond in one molecule.

Examples of the water-soluble ether solvent include tetrahydrofuran (THF), dioxane, trioxane, 1,2-dimethoxyethane, diethylene glycol dimethyl ether, and diethylene glycol diethyl ether. Among these, the water-soluble ether solvent is preferably tetrahydrofuran and dioxane.

The water-soluble ketone solvent is a water-soluble solvent having a ketone group in one molecule.

Examples of the water-soluble ketone solvent include acetone, methyl ethyl ketone, and cyclohexanone. Among these, the water-soluble ketone solvent is preferably acetone. The water-soluble alcohol solvent is a water-soluble solvent having an alcoholic hydroxy group in one molecule.

Examples of the water-soluble alcohol solvent include methanol, ethanol, 1-propanol, 2-propanol, tert-butyl alcohol, ethylene glycol, ethylene glycol monoalkyl ether, propylene glycol, propylene glycol monoalkyl ether, diethylene glycol, diethylene glycol monoalkyl ether, 1,2-propanediol, 1,3-propanediol, 1,3-butanediol, 1,4-butanediol, 2,3-butanediol, 1,5-pentanediol, 2-butene-1,4-diol, 2-methyl-2,4-pentanediol, glycerin, 2-ethyl-2-hydroxymethyl-1,3-propanediol, and 1,2,6-hexanetriol. Among these, the water-soluble alcohol solvent is preferably methanol, ethanol, 2-propanol, ethylene glycol, ethylene glycol monoalkyl ether, propylene glycol, propylene glycol monoalkyl ether, diethylene glycol, and diethylene glycol monoalkyl ether.

The other water-soluble organic solvents may be used alone or in combination of two or more thereof.

The other water-soluble organic solvents preferably have a boiling point of 270° C. or lower, more preferably 60° C. or higher and 250° C. or lower, and still more preferably 80° C. or higher and 230° C. or lower. When the boiling point of the water-soluble organic solvent is within the above range, the water-soluble organic solvent is less likely to remain on the porous polyimide film, and a porous polyimide film having high mechanical strength may be easily obtained.

The content of the aqueous solvent is preferably 75 mass % or more, and more preferably 80 mass % or more, with respect to the total mass of the polyimide precursor solution.

### <Water-Soluble Surfactant>

The polyimide precursor solution according to the present exemplary embodiment preferably contains a water-soluble surfactant. The “water-soluble” means that the target substance dissolves in water in an amount of 1 mass % or more at 25° C.

Examples of the water-soluble surfactant include a water-soluble nonionic surfactant and a water-soluble ionic surfactant.

Examples of the water-soluble nonionic surfactant include: ester nonionic surfactants having a structure in which a fatty acid is ester-bonded with a polyhydric alcohol such as glycerin, sorbitol, or sucrose; ether nonionic surfactants having a structure in which an alkylene oxide such as ethane oxide is added to a compound having a hydroxy group such as a higher alcohol or an alkylphenol; and ester-ether nonionic surfactant having a structure in which an alkylene oxide such as ethane oxide is added to a fatty acid or an ester of a polyhydric alcohol and a fatty acid, and a structure with both ester and ether bonds in the molecule.

The surfactant is preferably one that is easily thermally decomposed from the viewpoint of improving the surface aperture ratio.

The water-soluble nonionic surfactant is preferably a nonionic surfactant containing at least one selected from the group consisting of fluorine and silicon (hereinafter, a fluorine-containing nonionic surfactant may be referred to as a “fluorine-containing nonionic surfactant”, and a silicon-containing nonionic surfactant may be referred to as a “silicon-containing nonionic surfactant”).

Examples of the water-soluble nonionic surfactant are shown below, but the water-soluble nonionic surfactant is not limited thereto.

Examples of the ether nonionic surfactant include EMULGEN 103, EMULGEN 705, EMULGEN 709, and EMULGEN LS-114 (all manufactured by Kao Corporation).

Examples of the ester nonionic surfactant include LEODOR SP-L10, LEODOR Super SP-L10, and EMASOL 0-10V (manufactured by Kao Corporation).

Examples of the ester-ether nonionic surfactant include LEODOR TW-L120, LEODOR TW-0106V, and LEODOR MO-60 (all manufactured by Kao Corporation).

Examples of the fluorine-containing nonionic surfactant include MEGAFACE (registered trademark) F-410, F-444, F-477, and F-553 (all manufactured by DIC CORPORATION), LE-604 and LE-605 (both manufactured by KYOEISHA CHEMICAL Co., LTD), and PolyFox series PF-636, PF-6320, PF-656, and PF-6520 (all manufactured by OMNOVA Solutions).

Examples of the silicon-containing nonionic surfactant include POLYFLOW KL-401 and POLYFLOW KL-404 (both manufactured by KYOEISHA CHEMICAL Co., LTD), and BYK-307, BYK-333, and BYK-378 (all manufactured by BYK company).

The content of the water-soluble surfactant is preferably in the range of 3.3 mass % or more and 170 mass % or less, more preferably in the range of 7.5 mass % or more and 113 mass % or less, and still more preferably in the range of 15 mass % or more and 85 mass % or less, with respect to the entire polyimide precursor solution.

When the content of the water-soluble surfactant is within the above range, compared with the case where the amount is less than the above range, the dispersibility of the resin particles in the polyimide precursor solution is improved, and a porous polyimide film having a reduced variation in pore diameter may be obtained.

In addition, when the content of the water-soluble surfactant is within the above range, compared with the case where the amount is more than the above range, a porous polyimide film having a reduced uneven distribution of pores may be obtained. The porous polyimide film having a reduced uneven distribution of pores has an air permeability (s/100 mL) smaller than that of a porous polyimide film having an uneven distribution of pores.

From the viewpoint of achieving both reduction of variation in pore diameter and reduction of uneven distribution of pores in the porous polyimide film, the content of the water-soluble surfactant is preferably 5 parts by mass or more and 30 parts by mass or less, more preferably 5 parts by mass or more and 20 parts by mass or less, and still more preferably 5 parts by mass or more and 15 parts by mass or less, with respect to 100 parts by mass of the resin particles.

### <Other Additives>

The polyimide precursor solution according to the present exemplary embodiment may contain, as other additives, a catalyst for promoting the imidization reaction, a leveling material for improving the quality of film formation, and the like, if necessary.

As the catalyst for promoting the imidization reaction, a dehydrating agent such as an acid anhydride, and an acid catalyst such as a phenol derivative, a sulfonic acid derivative, and a benzoic acid derivative may be used.

In addition, the polyimide precursor solution according to the present exemplary embodiment may contain, for example, a conductive material (a conductive material (for example, having a volume resistivity less than 10⁷ Ω·cm) or a semi-conductive material (for example, having a volume resistivity 10⁷ Ω·cm or more and 10¹³ Ω·cm or less)) as a conductive agent added for imparting conductivity, depending on the intended use of the porous polyimide film.

Examples of the conductive agent include: carbon black (for example, acidic carbon black having a pH of 5.0 or less); metals (for example, aluminum or nickel); metal oxides (for example, yttrium oxide or tin oxide); and ionic conductive materials (for example, potassium titanate or LiCl).

The conductive agent may be used alone or in combination of two or more thereof.

Further, the polyimide precursor solution according to the present exemplary embodiment may contain inorganic particles added for improving mechanical strength of the porous polyimide film, depending on the intended use of the porous polyimide film. Examples of the inorganic particles include particulate materials such as silica powder, alumina powder, barium sulfate powder, titanium oxide powder, mica, and talc.

### <Method for Producing Polyimide Precursor Solution>

A method for producing the polyimide precursor solution is not particularly limited, and examples thereof include a production method including a resin particle dispersion liquid preparation step of preparing a resin particle dispersion liquid and a polyimide precursor formation step of forming a polyimide precursor.

### (Resin Particle Dispersion Liquid Preparation Step)

The method of the resin particle dispersion liquid preparation step is not particularly limited as long as a resin particle dispersion liquid in which the resin particles are dispersed in the aqueous solvent is obtained.

Examples thereof include a method of weighing resin particles that are insoluble in a polyimide precursor solution and an aqueous solvent for a resin particle dispersion liquid, mixing and stirring the above substances. The method of mixing and stirring the resin particles and the aqueous solvent is not particularly limited. Examples thereof include a method of mixing the resin particles with the aqueous solvent under stirring. From the viewpoint of enhancing the dispersibility of the resin particles, for example, at least one selected from the group consisting of an ionic surfactant and a nonionic surfactant may be contained in the resin particle dispersion liquid.

The resin particle dispersion liquid may be a resin particle dispersion liquid in which resin particles are granulated in the aqueous solvent. When the resin particles are granulated in the aqueous solvent, a resin particle dispersion liquid formed by polymerizing monomer components in the aqueous solvent may be prepared. In this case, it may be a resin particle dispersion liquid obtained by a known polymerization method. For example, when the resin particles are vinyl resin particles, a known polymerization method (for example, radical polymerization methods such as emulsion polymerization, soap-free emulsion polymerization, suspension polymerization, mini-emulsion polymerization, and micro-emulsion polymerization) may be applied.

For example, when applying the emulsion polymerization method to the production of vinyl resin particles, the vinyl resin particles are obtained by polymerization by adding a monomer having a vinyl group such as styrenes and (meth)acrylic acid to water in which a water-soluble polymerization initiator such as potassium persulfate and ammonium persulfate is dissolved, adding, if necessary, a surfactant such as sodium dodecyl sulfate and diphenyloxide disulfonate, and performing heating while stirring. Then, by using a monomer having an acidic group as a monomer component, a vinyl resin having an acidic group on the surface may be obtained. Resin particles having an acidic group on the surface are preferred since the dispersibility of the resin particles is enhanced.

The resin particle dispersion liquid preparation step is not limited to the above method, and a commercially available resin particle dispersion liquid in which the resin particles are dispersed in an aqueous solvent may be prepared. When a commercially available resin particle dispersion liquid is used, an operation such as dilution with an aqueous solvent may be performed depending on the purpose. Further, the aqueous solvent of the resin particle dispersion liquid in which the resin particles are dispersed in the aqueous solvent may be replaced with an organic solvent within a range of not influencing the dispersibility.

### (Polyimide Precursor Formation Step)

In the polyimide precursor formation step, for example, in a dispersion liquid in which resin particles are dispersed, a tetracarboxylic dianhydride and a diamine compound are polymerized in the presence of an organic amine compound to generate a resin (specifically, polyimide precursor) to obtain a polyimide precursor solution.

According to this method, since an aqueous solvent is applied, the productivity is high and the polyimide precursor solution is produced in one step, which is thus advantageous from the viewpoint of simplification of the process.

Specifically, an organic amine compound, a tetracarboxylic dianhydride, and a diamine compound are mixed with the dispersion liquid in which the resin particles are dispersed and which is prepared in the resin particle dispersion liquid preparation step. Then, the tetracarboxylic dianhydride and the diamine compound are polymerized in the presence of an organic amine compound, and thereby a polyimide precursor is formed in the resin particle dispersion liquid. The order of mixing the organic amine compound, the tetracarboxylic dianhydride, and the diamine compound with the resin particle dispersion liquid is not particularly limited.

When polymerizing the tetracarboxylic dianhydride and the diamine compound in the resin particle dispersion liquid in which the resin particles are dispersed, a polyimide precursor may be formed by using the aqueous solvent in the resin particle dispersion liquid as it is. If necessary, an aqueous solvent may be newly mixed. In the case of newly mixing an aqueous solvent, the aqueous solvent may be an aqueous solvent containing a small amount of an aprotic polar solvent. Other additives may be mixed depending on the purpose.

The polyimide precursor may be formed, for example, by polymerizing the tetracarboxylic dianhydride and the diamine compound in an organic solvent such as an aprotonic polar solvent (for example, N-methylpyrrolidone (NMP)) to generate a resin (specifically, polyimide precursor). In this case, for example, after the polyimide precursor is generated, a solution in which the polyimide precursor is dissolved in an organic solvent is added into the resin particle dispersion liquid obtained in the resin particle dispersion liquid preparation step to precipitate the resin (specifically, polyimide precursor), and then the polyimide precursor may be dissolved in an aqueous solvent by adding, for example, an organic amine compound.

With the above steps, a polyimide precursor solution in which the resin particles are dispersed is obtained.

As described above, a method of containing a water-soluble surfactant in the polyimide precursor solution is exemplified as one of the methods of setting the ratio of the volume frequency of the particles having a particle diameter of 150 nm or more to be 5% or less in the volume particle size distribution of the resin particles in the polyimide precursor solution. When the polyimide precursor solution contains a water-soluble surfactant, the water-soluble surfactant may be added before the polyimide precursor formation step, or may be contained in the resin particle dispersion liquid in advance.

### [Method for Producing Porous Polyimide Film]

A method for producing a porous polyimide film according to the present exemplary embodiment includes: a first step of coating the above polyimide precursor solution onto a substrate to form a coating film, and then drying the coating film to form a film containing the polyimide precursor and the resin particles; and a second step of heating the film to imidize the polyimide precursor to form a polyimide film, the second step including a treatment of removing the resin particles.

Hereinafter, an example of a suitable method for producing a porous polyimide film according to the present exemplary embodiment will be described with reference to the drawing.

The FIGURE is a schematic view showing a structure of a porous polyimide film obtained by the method for producing a porous polyimide film according to the present exemplary embodiment.

In the FIGURE, 31 denotes a substrate, 51 denotes a release layer, 10A denotes a pore, and 10 denotes a porous polyimide film.

### <First Step>

In the first step, the above polyimide precursor solution is coated onto the substrate to form a coating film, and then the coating film is dried to form a film containing the polyimide precursor and the resin particles.

The coating film is formed by coating the polyimide precursor solution obtained by the method described above onto the substrate. The obtained coating film contains at least a polyimide precursor, resin particles, and an aqueous solvent. The resin particles in the coating film are distributed in a state where aggregation is prevented.

The substrate to which the polyimide precursor solution is coated (that is, the substrate 31 in the FIGURE) is not particularly limited.

Examples of the substrate include a resin substrate made of polystyrene, polyethylene terephthalate or the like; a glass substrate; a ceramic substrate; a metallic substrate made of iron, stainless steel (SUS) or the like; and a composite material substrate made of a material combining the above these materials.

If necessary, the substrate may be provided with a release layer (that is, the release layer 51 in the FIGURE) by performing a release treatment with, for example, a silicone or fluorine release agent. It is also effective to roughen the surface of a base material to a size of about the particle diameter of the particles to promote the exposure of the particles on the contact surface of the base material.

The method of coating the polyimide precursor solution onto the substrate is not particularly limited, and examples thereof include various methods such as a spray coating method, a rotary coating method, a roll coating method, a bar coating method, a slit die coating method, and an inkjet coating method.

As the base material, various base materials may be used depending on the intended use. Examples of the base material include: various base materials applied to liquid crystal elements; semiconductor base materials on which integrated circuits are formed, wiring base material on which a wiring is formed, base materials on printed circuit boards on which electronic components and wiring are provided; and base materials for wire coating material.

The film is formed by drying the coating film formed on the substrate. The film contains at least a polyimide precursor and resin particles.

The method of drying the coating film formed on the substrate is not particularly limited, and examples thereof include various methods such as heat drying, natural drying, and vacuum drying.

More specifically, it is preferable to form the film by drying the coating film such that the solvent remaining in the film is 50% or less (preferably 30% or less) with respect to the solid content of the film.

A treatment of exposing the resin particles may be performed in the process of drying to form the film. By performing the treatment of exposing the resin particles, the porosity of the porous polyimide film is increased.

Specific examples of the treatment of exposing the resin particles include the methods shown below.

In the process of drying the coating film to form the film containing the polyimide precursor and the resin particles, the polyimide precursor in the formed film is in a state of being soluble in water as described above. Therefore, the resin particles are exposed from the film by, for example, wiping the film with water or immersing the film in water. Specifically, for example, the polyimide precursor covering the resin particles (and the solvent) is (are) removed by performing a treatment of exposing the resin particles by wiping the surface of the film with water. As a result, the resin particles are exposed on the surface of the treated film.

In particular, when a film in which the resin particles are embedded is formed, it is preferable to adopt the above treatment as a treatment of exposing the resin particles embedded in the film.

### <Second Step>

The second step is a step of heating the film obtained in the first step to imidize the polyimide precursor to form a polyimide film, and includes a treatment of removing the resin particles.

In the second step, specifically, the film obtained in the first step is heated to progress imidization and the polyimide film is thereby formed. As the imidization progresses and the imidization rate increases, the polyimide film is less soluble in the solvent.

In the second step, for heating to imidize the polyimide precursor in the film, for example, heating in two or more stages is preferably used. Specifically, for example, the following heating conditions are adopted.

The heating condition in the first stage is preferably a temperature at which the shape of the resin particles is maintained. The heating temperature in the first stage is preferably in the range of 50° C. or higher and 150° C. or lower, and more preferably in the range of 60° C. or higher and 140° C. or lower. The heating time in the first stage is preferably in the range of 10 minutes or longer and 60 minutes or shorter. The higher the heating temperature in the first stage, the shorter the heating time in the first stage may be.

Examples of the heating conditions in the second stage include heating at 150° C. or higher and 450° C. or lower (preferably 200° C. or higher and 400° C. or lower) for 20 minutes or longer and 120 minutes or shorter. When the heating conditions are set in these ranges, the imidization reaction further progresses. During the heating reaction, the temperature is preferably gradually increased stepwise or at a constant rate before the temperature reaches the final temperature of heating.

The heating conditions are not limited to the above two-stage heating method, and for example, a one-stage heating method may be adopted. In the case of the one-stage heating method, for example, the imidization may be completed only under the heating conditions shown in the second stage above.

In the second step, in addition to the imidization by heating, the resin particles are removed from the film obtained in the first step or the polyimide film obtained by the imidization. With the removal of the resin particles, a region where the resin particles are present becomes pores (that is, pores 10A in the FIGURE), and a porous polyimide film (that is, the porous polyimide film 10 in the FIGURE) is obtained.

The removal of the resin particles may be performed, for example, in the process of imidizing the polyimide precursor with respect to the film obtained in the first step, or after the imidization is completed.

Examples of the method of removing the resin particles from the film include a method of decomposing and removing the resin particles by heating, a method of dissolving and removing the resin particles with an organic solvent, and a method of removing the resin particles by decomposing the resin particles with a laser or the like.

In the case of using the method of decomposing and removing the resin particles by heating, this method may also serve as the imidization described above. That is, the particles may be removed by heating during the imidization.

These methods may be used alone or in combination of two or more thereof.

In the case of the method of decomposing and removing the resin particles by heating, it is preferable to heat the resin particles at a temperature equal to or higher than the melting temperature of the resin particles.

Examples of the method of dissolving and removing the resin particles with an organic solvent include a method of bringing the film or the polyimide film into contact with the organic solvent to dissolve and remove the resin particles with the organic solvent.

Examples of the method of bringing the film or the polyimide film into contact with the organic solvent include a method of immersing the film or the polyimide film in the organic solvent, a method of coating the organic solvent to the film or the polyimide film, and a method of bringing the film or the polyimide film into contact with vapor of the organic solvent.

The organic solvent that dissolves the resin particles is not particularly limited as long as it is an organic solvent that does not dissolve the polyimide precursor and the polyimide and may dissolve the resin particles.

Examples of the organic solvent include: ethers such as tetrahydrofuran and 1,4-dioxane; aromatic substances such as benzene and toluene; ketones such as acetone; and esters such as ethyl acetate.

Among these, preferred examples of the organic solvent include: ethers such as tetrahydrofuran and 1,4-dioxane; and aromatic substances such as benzene and toluene. Among these, more preferred examples of the organic solvent include tetrahydrofuran and toluene.

In the case of dissolving and removing the particles with an organic solvent, the method is preferably performed when the imidization ratio of the polyimide precursor in the film is 10% or more, from the viewpoint of improving the removability of particles and from the viewpoint of preventing the film from being dissolved in the organic solvent.

Examples of the method of setting the imidization ratio to 10% or more include a method of heating under the heating conditions of the first stage in the imidization of the second step.

That is, it is preferable that the particles in the film are dissolved and removed with an organic solvent after the heating in the first stage in the imidization of the second step is performed.

Here, the imidization ratio of the polyimide precursor will be described. Examples of a partially imidized polyimide precursor include a precursor having a structure having a repeating unit represented by the following general formula (I-1), the following general formula (I-2), and the following general formula (I-3).

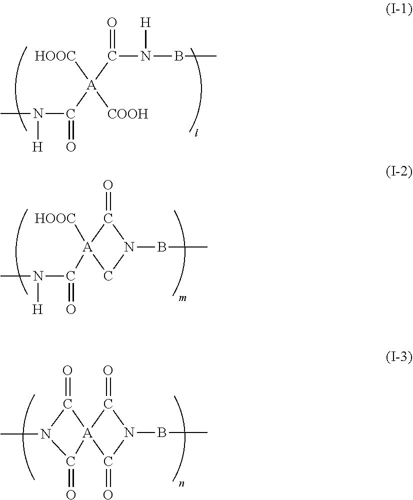

In the general formula (I-1), the general formula (I-2), and the general formula (I-3), A represents a tetravalent organic group and B represents a divalent organic group. 1 represents an integer of 1 or more, and m and n independently represent an integer of 0 or 1 or more.

A and B have the same meanings as A and B in the above general formula (I).

The imidization ratio of the polyimide precursor represents the ratio of the number of imide-ring-closed bond parts (2n+m) to the total number of bonds (2l+2m+2n) in the bonding part of the polyimide precursor (that is, reaction part of the tetracarboxylic dianhydride and the diamine compound). That is, the imidization ratio of the polyimide precursor is indicated by “(2n+m)/(2l+2m+2n)”. The imidization ratio of the polyimide precursor (that is, a value of “(2n+m)/(2l+2m+2n)”) is measured by the following method.

### —Measurement of Imidization Ratio of Polyimide Precursor—

### Preparation of Polyimide Precursor Sample

(i) A polyimide precursor solution to be measured is coated onto a silicon wafer in a film thickness range of 1μm or more and 10 μm or less to prepare a coating film sample.

(ii) The coating film sample is immersed in tetrahydrofuran (THF) for 20 minutes to replace the solvent in the coating film sample with tetrahydrofuran (THF). The solvent for immersion is not limited to THF, and is selected from a solvent that does not dissolve the polyimide precursor and may be miscible with the solvent component contained in the polyimide precursor solution. Specifically, alcohol solvents such as methanol and ethanol, and ether compounds such as dioxane are used.

(iii) The coating film sample is taken out from the THF, and N₂ gas is sprayed onto the THF adhering to the surface of the coating film sample to remove the THF. A treatment is performed for 12 hours or longer in a range of 5° C. or higher and 25° C. or lower under a reduced pressure of 10 mmHg or less to dry the coating film sample, so as to prepare a polyimide precursor sample.

### Preparation of 100% Imidized Standard Sample

(iv) In the same manner as in (i) above, a polyimide precursor solution to be measured is coated onto a silicon wafer to prepare a coating film sample.

(v) The coating film sample is heated at 380° C. for 60 minutes to carry out an imidization reaction to prepare a 100% imidized standard sample.

### Measurement and Analysis

(vi) Infrared absorption spectra of the 100% imidized standard sample and the polyimide precursor sample are measured using a Fourier transform infrared spectrophotometer (FT-730, manufactured by HORIBA, Ltd.). The ratio I (100) of the absorption peak (Ab(1780 cm⁻¹)) derived from the imide bond near 1780 cm⁻¹ to the absorption peak (Ab(1500 cm⁻¹)) derived from the aromatic ring near 1500 cm⁻¹ in the 100% imidized standard sample is determined.

(vii) Similarly, the polyimide precursor sample is measured, and the ratio I (x) of the absorption peak (Ab(1780 cm⁻¹)) derived from the imide bond near 1780 cm⁻¹ to the absorption peak (Ab(1500 cm⁻¹)) derived from the aromatic ring near 1500 cm⁻¹ is determined.

Then, using the measured absorption peaks I(100) and I(x), the imidization ratio of the polyimide precursor is calculated based on the following equations.
Equation: Imidization ratio of polyimide precursor=I(x)/I(100)
Equation: I(100)=(Ab(1780 cm⁻¹))/(Ab(1500 cm⁻¹))
Equation: I(x)=(Ab(1780 cm⁻¹))/(Ab(1500 cm⁻¹))

The measurement of the imidization ratio of the polyimide precursor is applied to the measurement of the imidization ratio of an aromatic polyimide precursor. When measuring the imidization ratio of an aliphatic polyimide precursor, a peak derived from a structure that does not change before and after the imidization reaction is used as an internal standard peak instead of the absorption peak of the aromatic ring.

The substrate used in the first step may be peeled off from the film after the first step, may be peeled off from the polyimide film before removing the particles in the second step, or may be peeled off from the porous polyimide film obtained after the second step.

As described above, the porous polyimide film is produced.

### <Porous Polyimide Film>

The porous polyimide film obtained by the method for producing a porous polyimide film according to the present exemplary embodiment has a reduced variation in pore diameter.

The porosity of the porous polyimide film is not particularly limited. The porosity of the porous polyimide film is preferably 30% or more, more preferably 40% or more, and still more preferably 50% or more. The upper limit of the porosity is not particularly limited, and the porosity is preferably in the range of 90% or less.

Here, the porosity of the porous polyimide film is obtained based on the apparent density and the true density of the porous polyimide film.

The apparent density d is a value obtained by dividing the mass (g) of the porous polyimide film by the volume (cm³) of the porous polyimide film including the pores. The apparent density d may be obtained by dividing the mass per unit area (g/m²) of the porous polyimide film by the thickness (pm) of the porous polyimide film.

The true density p is a value obtained by dividing the mass (g) of the porous polyimide film by the volume (cm³) of the porous polyimide film excluding the pores (that is, the volume of only the skeleton portion made of resin).

The porosity of the porous polyimide film is calculated according to the following formula (II).

Porosity (%)={1−(d/ρ)}×100=[1−{(w/t)/ρ}]×100 Equation (II)

d: Apparent density (g/cm³) of porous polyimide film

ρ: True density (g/cm³) of porous polyimide film

w: Mass per unit area (g/m²) of porous polyimide film

t: Thickness (pm) of porous polyimide film

The shape of the pores is preferably spherical or close to spherical. Further, it is preferable that the pores have a continuous shape in which the pores are connected to each other.

The average value of the pore diameter is preferably a range of 5 nm or more and 100 nm or less, more preferably a range of 10 nm or more and 95 nm or less, and still more preferably a range of 20 nm or more and 90 nm or less.

The average value of the pore diameter is a value observed and measured by a scanning electron microscope (SEM). Specifically, first, a porous polyimide film is cut out in the thickness direction, and a measurement sample having the cut surface as the measurement surface is prepared. Then, the measurement sample is observed and measured by VE SEM manufactured by KEYENCE CORPORATION using image processing software included in the VE SEM as standard. The observation and measurement are separately performed on 100 pores in the cross section of the measurement sample, the distribution of the pore diameter is obtained, and the average value of the pore diameter is obtained by averaging the obtained values. When the shape of the pore is not circular, the longest part is regarded as the diameter.

The air permeability of the porous polyimide film is preferably 2,000 s/100 mL or less, more preferably 1,000 s/100 mL or less, and still more preferably 300 s/100 mL or less. The smaller the value of the air permeability, the more the uneven distribution of pores is prevented. The lower limit of the air permeability of the porous polyimide film is not particularly limited, and examples thereof include 5 s/100 mL. The air permeability of the porous polyimide film is measured by using an air permeability test method, i.e., the Gurley method (JIS P 8117: 2009).

### (Average Film Thickness of Porous Polyimide Film)

The average film thickness of the porous polyimide film produced by using the polyimide precursor solution according to the present exemplary embodiment is not particularly limited and is selected according to the intended use.

The average film thickness of the porous polyimide film may be, for example, 10 μm or more and 1000 μm or less. The average film thickness of the porous polyimide film is preferably 20 μm or more, and more preferably 30 μm or more. Further, the average film thickness of the porous polyimide film is preferably 500 μm or less, and more preferably 400 μm or less.

The average film thickness of the porous polyimide film is calculated by measuring the film thickness of the porous polyimide film at five points using an eddy current film thickness meter CTR-1500E manufactured by SANKO ELECTRONICS and calculating the arithmetic average of the film thicknesses at the five points.

### (Use of Porous Polyimide Film)

Examples of the use of the porous polyimide film according to the present exemplary embodiment include: battery separators for lithium secondary batteries, lithium metal secondary batteries, etc.; separators for electrolytic capacitors; electrolyte membranes for fuel cells, etc.; battery electrode materials; gas or liquid separation membranes; low dielectric constant materials; and filter membranes.

### EXAMPLES

Examples will be described below, but the present invention is not limited to these Examples. In the following description, all “parts” and “%” are based on mass unless otherwise specified. s

[Preparation of Resin Particle Dispersion Liquid]

### <Preparation of Resin Particle Dispersion Liquid (1)>

770 parts by mass of styrene, 230 parts by mass of butyl acrylate, 20 parts by mass of acrylic acid, 43.4 parts by mass of a surfactant Dowfax2A1 (a 47% solution, manufactured by Dow Chemical Company), and 2,800 parts by mass of ion-exchanged water are mixed, and the mixture is stirred and emulsified at 1,500 rpm for 30 minutes with a dissolver to prepare a monomer emulsion liquid. After heating to 60° C. under a nitrogen stream, a polymerization initiator solution in which 15 parts by mass of ammonium persulfate is dissolved in 70 parts by mass of ion-exchanged water is added at once. After reacting for 360 minutes, the mixture is cooled to obtain a resin particle dispersion liquid (1), i.e., a dispersion liquid of styrene-acrylic resin particles having an acidic group on the surface. The solid content concentration of the resin particle dispersion liquid (1) is 25.3 mass %. The volume average particle diameter of the resin particles is 69 nm.

### <Preparation of Resin Particle Dispersion Liquid (2)>

A resin particle dispersion liquid (2), i.e., a dispersion liquid of styrene-acrylic resin particles having an acidic group on the surface, is obtained in the same manner as the resin particle dispersion liquid (1), except that the surfactant is changed to 108 parts by mass and ammonium persulfate is changed to 11 parts by mass. The solid content concentration of the resin particle dispersion liquid (2) is 25 mass %. The volume average particle diameter of the resin particles is 50 nm.

### <Preparation of Resin Particle Dispersion Liquid (3)>

A resin particle dispersion liquid (3), i.e., a dispersion liquid of styrene-acrylic resin particles having an acidic group on the surface, is obtained in the same manner as the resin particle dispersion liquid (1), except that the surfactant is changed to 34.7 parts by mass and ammonium persulfate is changed to 11 parts by mass. The solid content concentration of the resin particle dispersion liquid (3) is 23 mass %. The volume average particle diameter of the resin particles is 89 nm.

### <Preparation of Resin Particle Dispersion Liquid (4)>

A resin particle dispersion liquid (4), i.e., a dispersion liquid of styrene resin particles having an acidic group on the surface, is obtained in the same manner as the resin particle dispersion liquid (1), except that the type of the resin is changed to only 1020 parts by mass of styrene and ammonium persulfate is changed to 11 parts by mass. The solid content concentration of the resin particle dispersion liquid (4) is 25 mass %. The volume average particle diameter of the resin particles is 65 nm.

### [Preparation of Polyimide Precursor Solution]

### Example 1

To 84.9 g of the resin particle dispersion liquid (1) (21.2 g of resin particles in terms of solid content), 101.5 g of ion-exchanged water and 3.6 g of Dowfax 2A1 (47% solution, manufactured by Dow Chemical Company) as a water-soluble surfactant are added to adjust the solid content concentration of the resin particle dispersion liquid (1) to 11 mass %. To the resin particle dispersion liquid, 2.28 g (21.1 mmol) of p-phenylenediamine (molecular weight: 108.14), 6.21 g (21.1 mmol) of 3,3,4,4-biphenyltetracarboxylic dianhydride (molecular weight: 294.22) are added and stirred at 50° C. for 10 minutes for dispersion. Then, a mixed liquid containing 4.46 g (44.1 mmol) of N-methylpyrrolidone (as organic amine compound), 6.4 g (63.3 mmol) of 4-methylmorpholin, and 7.64 g of ion-exchanged water are slowly added thereto, and the mixture is dissolved and reacted by stirring for 24 hours while maintaining the reaction temperature at 50° C., to obtain a polyimide precursor solution (PAA-1) in which resin particles are dispersed.

In the obtained polyimide precursor solution (PAA-1), the content of the resin particles with respect to 100 parts by mass of the polyimide precursor is 250 parts by mass, and the content of the water-soluble surfactant with respect to 100 parts by mass of the resin particles is 10 parts by mass.

In the obtained polyimide precursor solution (PAA-1), the content (mass %) of the water-soluble surfactant with respect to the polyimide precursor is shown in Table 1 (“Content (mass %)” in Table 1).

In addition, Table 1 shows the results of measuring, by the above-mentioned methods, the volume average particle diameter of the resin particles (“Volume average particle diameter (nm)” in Table 1), the ratio of the volume frequency of the particles having a particle diameter of 150 nm or more in the volume particle size distribution (“150 nm ratio (%)” in Table 1), and the volume particle size distribution index (“Volume particle size distribution index” in Table 1) for the obtained polyimide precursor solution (PAA-1).

### Examples 2 and 3

Polyimide precursor solutions (PAA-2) and (PAA-3) are obtained in the same manner as in Example 1 except that the amount of Dowfax2A1 (manufactured by Dow Chemical Conpany) as a water-soluble surfactant is changed to make the content (mass %) of the water-soluble surfactant with respect to the polyimide precursor the values shown in Table 1.

Table 1 shows the results of measuring, by the above-mentioned methods, the volume average particle diameter of the resin particles, the ratio of the volume frequency of the particles having a particle diameter of 150 nm or more in the volume particle size distribution, and the volume particle size distribution index for the obtained polyimide precursor solutions (PAA-2) and (PAA-3).

### Examples 4 to 6

Polyimide precursor solutions (PAA-4) to (PAA-6) are obtained in the same manner as in Example 1 except that the resin particle dispersion liquids (2) to (4) are used instead of the resin particle dispersion liquid (1), respectively.

In the obtained polyimide precursor solutions (PAA-4) to (PAA-6), the content of the resin particles with respect to 100 parts by mass of the polyimide precursor is the same as that of the polyimide precursor solution (PAA-1) in Example 1.

Table 1 shows the content (mass %) of the water-soluble surfactant with respect to the polyimide precursor in the obtained polyimide precursor solution.

In addition, Table 1 shows the results of measuring, by the above-mentioned methods, the volume average particle diameter of the resin particles, the ratio of the volume frequency of the particles having a particle diameter of 150 nm or more in the volume particle size distribution, and the volume particle size distribution index for the obtained polyimide precursor solutions (PAA-4) to (PAA-6).

### Comparative Example 1

A polyimide precursor solution (PAA-C1) is obtained in the same manner as in Example 1 except that Dowfax2A1 (manufactured by Dow Chemical Company) as a water-soluble surfactant is not added.

In the obtained polyimide precursor solution (PAA-C1), the content of the resin particles with respect to 100 parts by mass of the polyimide precursor is the same as that of the polyimide precursor solution (PAA-1) in Example 1.

In addition, Table 1 shows the results of measuring, by the above-mentioned methods, the volume average particle diameter of the resin particles, the ratio of the volume frequency of the particles having a particle diameter of 150 nm or more in the volume particle size distribution, and the volume particle size distribution index for the obtained polyimide precursor solution (PAA-C1).

### [Evaluation]

### <Production of Porous Polyimide Film>

First, an aluminum made base material (hereinafter referred to as an aluminum base material) for forming a coating film of the polyimide precursor solution is prepared. The surface of the aluminum base material is washed with toluene for use.

Next, the obtained polyimide precursor solution is coated onto the aluminum base material such that the film thickness after drying is 30μm to form a coating film, and the coating film is dried at 80° C. for 30 minutes. Then, the temperature is raised from room temperature (25° C., the same applies hereinafter) to 400° C. at a rate of 10° C./min, held at 400° C. for 1 hour, and then cooled to room temperature to obtain a porous polyimide film having a film thickness of 25 μm.

### <Evaluation of Distribution of Pore Diameter and Measurement of Average Value of Pore Diameter>

For the obtained porous polyimide film, the distribution of the pore diameter and the average value of the pore diameter are determined by the above-mentioned methods. The evaluation criteria for the distribution of the pore diameter are as follows, and the results are shown in Table 1.

(Evaluation criteria for distribution of pore diameter)

A: pore exceeding the range of ±10 nm from the average value of the pore diameter is 15 number% or less

B: pore exceeding the range of ±10 nm from the average value of the pore diameter is more than 15 number% and 30 number% or less

C: pore exceeding the range of ±10 nm from the average value of the pore diameter is more than 30 number%

### <Measurement of Air Permeability>

A measurement sample for the air permeability is prepared from the obtained porous polyimide film according to the air permeability test method, i.e., the Gurley method (JIS P 8117: 2009). Using the obtained measurement sample, the air permeability is measured by the method described above. The results are shown in Table 1.

TABLE 1

| | | Resin particles | | | Evaluation | | |
|---|---|---|---|---|---|---|---|
| | | Volume | | Volume | Average | | |
| | | average | 150 | particle | value | Distri- | |
| | Surfactant | particle | nm | size | of pore | bution | Air |
| | Content | diameter | ratio | distribution | diameter | of pore | permeability |
| | (mass %) | (nm) | (%) | index | (nm) | diameter | (s/100 mL) |
| Example 1 | 25 | 78 | 0.02 | 1.25 | 59 | A | 244 |
| Example 2 | 166 | 86 | 0.13 | 1.26 | 56 | B | 1856 |
| Example 3 | 3.3 | 95 | 0.29 | 1.26 | 87 | B | 2038 |
| Example 4 | 25 | 62 | 0 | 1.24 | 49 | A | 378 |
| Example 5 | 25 | 99 | 4.29 | 1.26 | 90 | B | 221 |
| Example 6 | 25 | 79 | 0.04 | 1.25 | 59 | A | 259 |
| Comparative | 1.3 | 4021 | 98 | Incomputable | 3890 | C | 193 |
| Example 1 | | | | because of | | | |
| | | | | two peaks | | | |

From the above results, it may be seen that in Examples, a porous polyimide film having a reduced variation in pore diameter may be obtained as compared with Comparative Example.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments are chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A polyimide precursor solution, comprising:
a polyimide precursor;
resin particles having a volume average particle diameter of 5 nm or more and 100 nm or less, and having a volume particle size distribution wherein a ratio of a volume frequency of resin particles having a particle diameter of 150 nm or more to a volume frequency of all of the resin particles in the polyimide precursor solution is 5% or less; and
an aqueous solvent containing water.

2. The polyimide precursor solution according to claim 1,
wherein the ratio of the volume frequency of the resin particles having a particle diameter of 150 nm or more to the volume frequency of all of the resin particles in the polyimide precursor solution is 3% or less.

3. The polyimide precursor solution according to claim 1, further comprising a water-soluble surfactant,
wherein a content of the water-soluble surfactant is in a range of 3.3 mass % or more and 170 mass % or less with respect to the polyimide precursor.

4. The polyimide precursor solution according to claim 2, further comprising a water-soluble surfactant,
wherein a content of the water-soluble surfactant is in a range of 3.3 mass % or more and 170 mass % or less with respect to the polyimide precursor.

5. A polyimide precursor solution, comprising:
a polyimide precursor;
resin particles having a volume average particle diameter of 5 nm or more and 100 nm or less;
an aqueous solvent containing water; and
a water-soluble surfactant,
wherein a content of the water-soluble surfactant is in a range of 3.3 mass % or more and 170 mass % or less with respect to the polyimide precursor.

6. The polyimide precursor solution according to claim 3,
wherein the content of the water-soluble surfactant is in a range of 7.5 mass % or more and 113 mass % or less with respect to the polyimide precursor.

7. The polyimide precursor solution according to claim 4,
wherein the content of the water-soluble surfactant is in a range of 7.5 mass % or more and 113 mass % or less with respect to the polyimide precursor.

8. The polyimide precursor solution according to claim 5,
wherein the content of the water-soluble surfactant is in a range of 7.5 mass % or more and 113 mass % or less with respect to the polyimide precursor.

9. The polyimide precursor solution according to claim 1,
wherein a volume particle size distribution index of the resin particles is 1.40 or less.

10. The polyimide precursor solution according to claim 2,
wherein a volume particle size distribution index of the resin particles is 1.40 or less.

11. The polyimide precursor solution according to claim 3,
wherein a volume particle size distribution index of the resin particles is 1.40 or less.

12. The polyimide precursor solution according to claim 4,
wherein a volume particle size distribution index of the resin particles is 1.40 or less.

13. The polyimide precursor solution according to claim 5,
wherein a volume particle size distribution index of the resin particles is 1.40 or less.

14. The polyimide precursor solution according to claim 6,
wherein a volume particle size distribution index of the resin particles is 1.40 or less.

15. The polyimide precursor solution according to claim 7,
wherein a volume particle size distribution index of the resin particles is 1.40 or less.

16. The polyimide precursor solution according to claim 1,
wherein a content of the water is 70 mass % or more with respect to the aqueous solvent.

17. The polyimide precursor solution according to claim 1,
wherein the resin particles contain a vinyl resin.

18. The polyimide precursor solution according to claim 17,
wherein the vinyl resin includes at least one selected from the group consisting of a polystyrene resin, an acrylic resin, a methacrylic resin, an acrylic acid ester resin, a methacrylic acid ester resin, a styrene-acrylic resin, and a styrene-methacrylic resin.

19. The polyimide precursor solution according to claim 1,
wherein a content of the resin particles with respect to 100 parts by mass of the polyimide precursor is 65 parts by mass or more and 600 parts by mass or less.

20. A method for producing a porous polyimide film comprising:
coating the polyimide precursor solution according to claim 1 onto a substrate to form a coating film, and drying the coating film to form a film containing the polyimide precursor and the resin particles; and
heating the film to imidize the polyimide precursor to form a polyimide film, and removing the resin particles.
